(19) United States
(12) Patent Application Publication
(10) Pub. No.: US 2015/0365340 A1
(43) Pub. Date: Dec. 17, 2015

(54) PACKET TRANSMISSION APPARATUS AND PACKET RECEPTION APPARATUS

(71) Applicant: FUJITSU LIMITED, Kawasaki-shi (JP)

(72) Inventors: Nobuyuki FUKUDA, Yokohama (JP); Shigeaki KAWAMATA, Sagamihara (JP); Yutaka AOYAMA, Yokohama (JP); Masumi KOBAYASHI, Kawasaki (JP)

(21) Appl. No.: 14/710,128

(22) Filed: May 12, 2015

(30) Foreign Application Priority Data
Jun. 13, 2014 (JP) 2014-122414

(51) Int. Cl. H04L 12/865; H04L 12/851; H04L 29/06

(52) U.S. Cl. CPC H04L 47/6275; H04L 69/166; H04L 47/24

(57) ABSTRACT

A packet transmission apparatus includes: while data included in a preceding packet having a low priority is being transmitted without fragmentation, when time has come to transmit a succeeding packet having a priority higher than that of the preceding packet, one or more processors configured to perform conversion processing for dividing the preceding packet into a plurality of fragment packets while the data is being transmitted; and a transmission unit configured to transmit the succeeding packet between a first fragment packet, and a second fragment packet among the plurality of fragment packets.

### CROSS-REFERENCE TO RELATED APPLICATION

This application is based upon and claims the benefit of priority of the prior Japanese Patent Application No. 2014-122414, filed on Jun. 13, 2014, the entire contents of which are incorporated herein by reference.

### FIELD

The embodiments discussed herein are related to a packet transmission apparatus, and a packet reception apparatus.

### BACKGROUND

In an Internet Protocol (IP) network, as a protocol for adjusting an internal clock of an apparatus connected to the IP network in order to correct time, for example, a Network Time Protocol (NTP), or the like is used. In order to take synchronism among a plurality of apparatuses connected to the IP network with high precision, it is desirable that fluctuations of a packet (hereinafter, sometimes referred to as an “NTP packet”) to be transmitted in accordance with NTP are small. Accordingly, a transmission priority of an NTP packet is normally set high compared with the transmission priority of a packet other than the NTP packet.

In the following, if the transmission priority is equal to or higher than a threshold value, it is sometimes called “high priority”, and if the transmission priority is less than the threshold value, it is sometimes called “low priority”. Also, a packet having the transmission priority (hereinafter, sometimes referred to simply as a “priority”) that is equal to or higher than a threshold value is sometimes called a “high priority packet”, and a packet having the transmission priority less than the threshold value is sometimes called a “low priority packet”. That is to say, an NTP packet is a high priority packet.

Related-art techniques are disclosed in International Publication Pamphlet No. WO 2005/013576, and Japanese Laid-Open Patent Publication Nos. 2001-024702, 2003-069603, and 2006-050503.

FIG. 1 is a diagram for use in explaining problems. In a related-art packet transmission apparatus, while a preceding packet is being transmitted, when time has come to transmit a succeeding packet, transmission of the succeeding packet is waited until transmission completion of the preceding packet, and the succeeding packet is transmitted after transmission completion of the preceding packet. Accordingly, although the preceding packet is a low priority packet, and the succeeding packet is a high priority packet, transmission of the high priority packet is waited until transmission completion of the low priority packet, and thus a transmission delay of the high priority packet sometimes occurs. The larger the amount of data of the low-priority preceding packet, the larger the delay time of the high-priority succeeding packet becomes. Thus, for example if the succeeding packet is an NTP packet, the fluctuations of the NTP packet becomes large because of the existence of the low-priority preceding packet, and thus it sometimes becomes difficult to establish synchronism of time with high precision.

The disclosed technique has been made in view of the above, and it is desirable to avoid a transmission delay of a high priority packet because of the existence of a low priority packet.

### SUMMARY

According to an aspect of the invention, a packet transmission apparatus, comprising: while data included in a preceding packet having a low priority is being transmitted without fragmentation, when time has come to transmit a succeeding packet having a priority higher than that of the preceding packet, one or more processors configured to perform conversion processing for dividing the preceding packet into a plurality of fragment packets while the data is being transmitted; and a transmission unit configured to transmit the succeeding packet between a first fragment packet, and a second fragment packet among the plurality of fragment packets.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram for use in explaining problems;

FIG. 2 illustrates an example of a packet format according to a first embodiment;

FIG. 3 illustrates an example of an IP header format according to the first embodiment;

FIG. 4 illustrates an example of an option header format according to the first embodiment;

FIG. 5 illustrates an example of an option footer format according to the first embodiment;

FIG. 6 illustrates an example of a configuration of a communication system according to the first embodiment;

FIG. 7 is a functional block diagram illustrating an example of a packet transmission apparatus according to the first embodiment;

FIG. 8 is a functional block diagram illustrating an example of a packet reception apparatus according to the first embodiment;

FIG. 9 is a diagram for use in explaining operation of the packet transmission apparatus according to the first embodiment;

FIG. 10 is a diagram for use in explaining operation of the packet transmission apparatus according to the first embodiment;

FIG. 11 is a diagram for use in explaining operation of the packet reception apparatus according to the first embodiment;

FIG. 12 is a method for use in explaining processing of the packet transmission apparatus according to the first embodiment;

FIG. 13 is a method for use in explaining processing of the packet reception apparatus according to the first embodiment; and

FIG. 14 illustrates an example of a hardware configuration of the packet transmission apparatus and the packet reception apparatus.

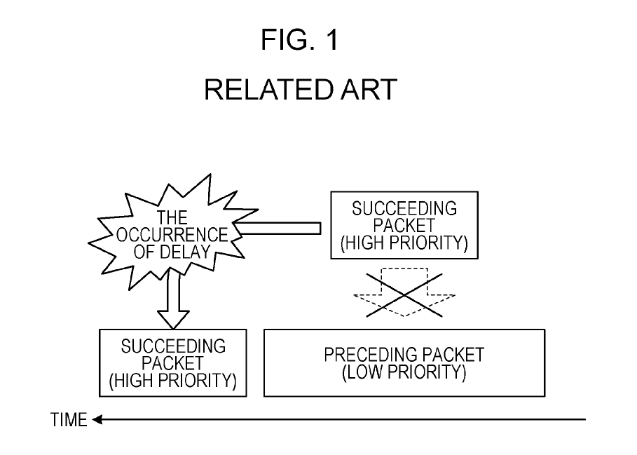

### DESCRIPTION OF EMBODIMENTS

In the following, a detailed description will be given of embodiments of a packet transmission apparatus and a packet reception apparatus according to the present disclosure based on the drawings. In this regard, these embodiments will not limit the packet transmission apparatus and the packet reception apparatus according to the present disclosure. Also, in each of the embodiments, the same symbol is given to a configuration having the same functions, and to an operation in which the same processing is performed, and a duplicated description will be omitted.

Also, in the following, a description will be given of on the assumption that a protocol to be used is IP.

<Packet Format>

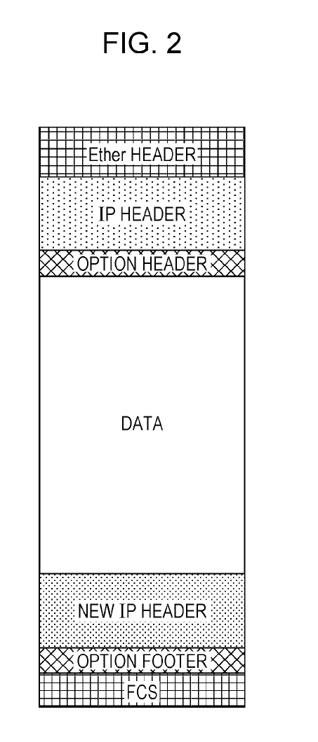

FIG. 2 illustrates an example of a packet format according to a first embodiment. The packet format illustrated in FIG. 2 is the format of a fragment packet produced by the processing in which while data included in a low-priority preceding packet is being transmitted, when time has come to transmit a high-priority succeeding packet, conversion processing is performed for dividing the preceding packet into a plurality of fragment packets while the data is being transmitted. As illustrated in FIG. 2, such a fragment packet includes an Ether header, an IP header, an option header, data, a new IP header, an option footer, and a frame check sequence (FCS), and thus the new IP header is added to immediately after the data.

The Ether header includes a media access control (MAC) address of a transmission destination, and a MAC address of a transmission source.

Descriptions will be given later of the formats of the IP header, the option header, the new IP header, and the option footer.

The FCS is added in order to perform error check from the Ether header to the data.

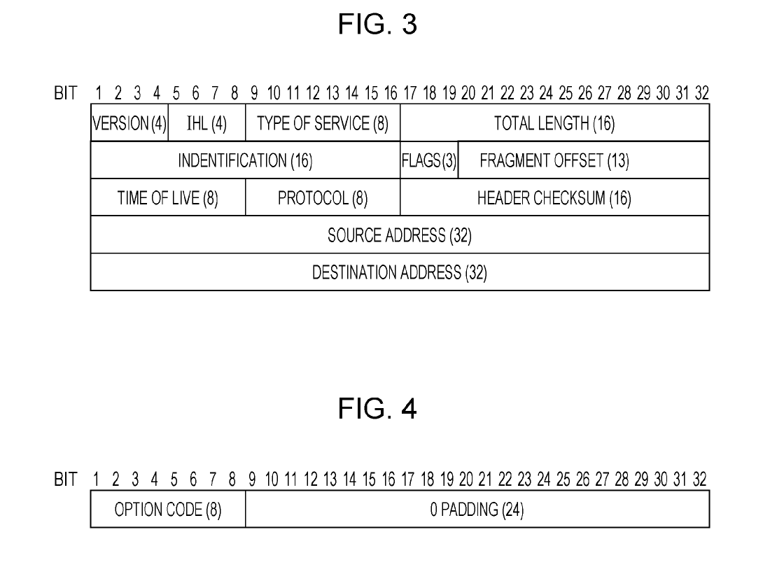

FIG. 3 illustrates an example of an IP header format according to the first embodiment. The IP header and the new IP header have formats illustrated in FIG. 3. The numeric values in the parentheses indicate bit lengths.

In FIG. 3, “Version” indicates a version of the IP protocol.

“Internet header Length (IHL)” indicates the header length including options.

“Type of Service” indicates the service quality of the packet, and includes a differentiated services code point (DSCP). A priority is given to each packet using DSCP, and each packet is classified into either a low priority packet or a high priority packet, for example.

“Total Length” indicates the total data length including the header, and the data.

“Identification” is an identifier of a fragment packet, and it is possible to determine whether the packet is a fragment packet or not by “Identification”.

“Flags” indicates control information concerning a fragment. Among three bits, bit0 to bit2, bit0 is set to “0: reserved”, and bit1 is set to either “0: fragment permitted” or “1: fragment prohibited”. Also, bit2 is set to either “0: final fragment” or “1: fragment continued”.

“Fragment Offset” indicates at which position in the data of the original packet before fragmenting, the starting position of the data in the fragment packet corresponds in units of 8 octets.

“Time to Live” indicates the maximum time period during which a packet is allowed to continue to exist in the Internet system. “Protocol” is the next level protocol used in the data section of the packet. “Header Checksum” indicates the checksum of only the header. “Source Address” indicates the IP address of the transmission source. “Destination Address” indicates the IP address of the transmission destination.

FIG. 4 illustrates an example of an option header format according to the first embodiment. The option header has the format illustrated in FIG. 4. The numeric values in the parentheses indicate the bit lengths. “Option Code” indicates whether or not the packet is in a mode in which while data included in a low-priority preceding packet is being transmitted, when time has come to transmit a high-priority succeeding packet, the preceding packet is divided and converted into fragment packets. For example, in the following, it is assumed that a transmission mode in which while data of a low-priority preceding packet is being transmitted, the preceding packet is divided and converted into fragment packets is referred to as “mode1”, and a transmission mode in which fragmenting is not performed is referred to as “mode0”. It is possible to set this transmission mode by a user parameter.

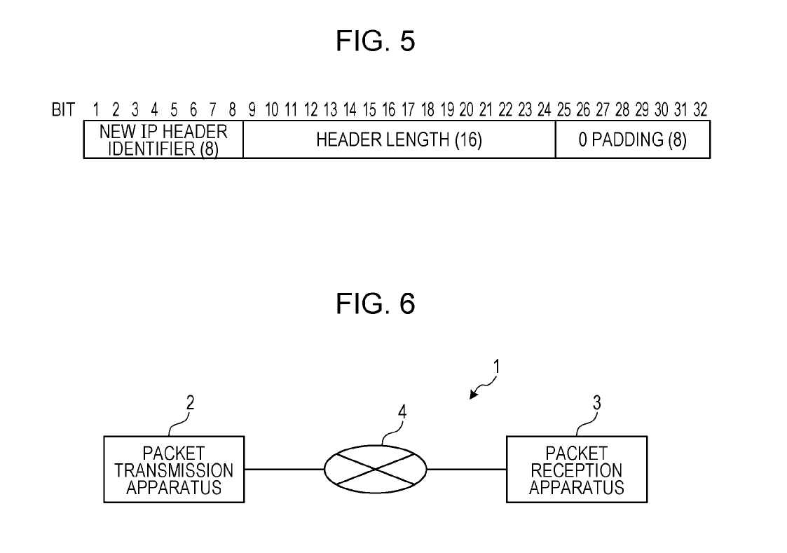

FIG. 5 illustrates an example of an option footer format according to the first embodiment. The option footer has the format illustrated in FIG. 5. The numeric values in the parentheses indicate the bit lengths. “Identifier of the new IP header” is an identifier that indicates whether there is a new IP header or not, that is to say, whether a new IP header is added or not. “Header length” indicates the header length of the new IP header in units of octets when a new IP header is added.

<Configuration of Communication System>

FIG. 6 illustrates an example of a configuration of a communication system according to the first embodiment. In FIG. 6, a communication system 1 includes a packet transmission apparatus 2, a packet reception apparatus 3, and a network 4.

The packet transmission apparatus 2 transmits low priority packets and high priority packets to the packet reception apparatus 3 through the network 4.

The packet reception apparatus 3 receives low priority packets and high priority packets from the packet transmission apparatus 2 through the network 4.

<Configuration of Packet Transmission Apparatus>

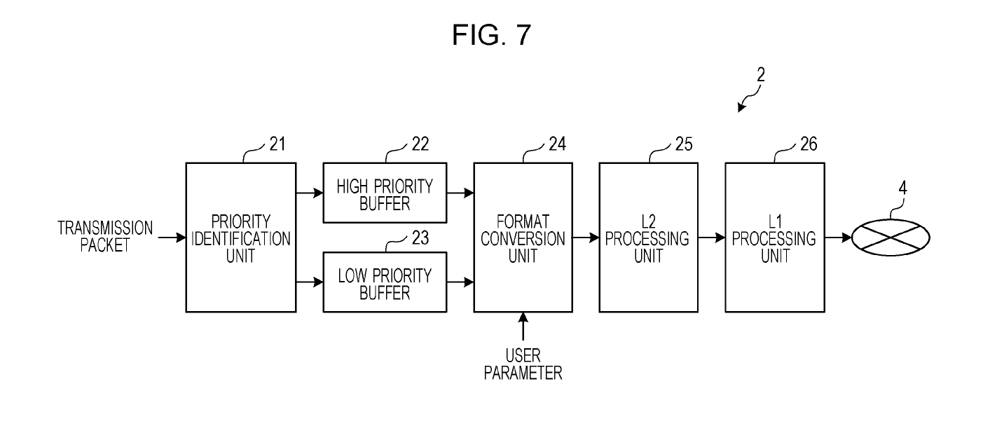

FIG. 7 is a functional block diagram illustrating an example of a packet transmission apparatus according to the first embodiment. The packet transmission apparatus 2 illustrated in FIG. 7 includes a priority identification unit 21, a high priority buffer 22, a low priority buffer 23, a format conversion unit 24, an L2 (layer2) processing unit 25, and an L1 (layer1) processing unit 26. The priority identification unit 21, the high priority buffer 22, the low priority buffer 23, and the format conversion unit 24 perform processing in L3 (layer3).

The priority identification unit 21 receives a transmission packet including data and an added IP header, which is input from a preceding functional unit. The priority identification unit 21 refers to a DSCP included in “Type of Service” of the IP header, determines whether the input transmission packet is a high priority packet or a low priority packet, stores a high priority packet into the high priority buffer 22, and stores a low priority packet into the low priority buffer 23.

The high priority buffer 22 is a buffer for storing high priority packets, and when a high priority packet is input from the priority identification unit 21, the high priority buffer 22 issues a transmission request of the high priority packet to the format conversion unit 24.

The low priority buffer 23 is a buffer for storing low priority packets, and when a low priority packet is input from the priority identification unit 21, the low priority buffer 23 issues a transmission request of the low priority packet to the format conversion unit 24.

The format conversion unit 24 performs the following processing when “mode0”, that is to say, a transmission mode of not carrying out fragmenting is specified by an input user parameter. That is to say, the format conversion unit 24 first reads a high priority packet from the high priority buffer 22, and after completion of reading a high priority packet, the format conversion unit 24 reads a low priority packet from the low priority buffer 23 in accordance with a transmission request from the high priority buffer 22 or the low priority buffer 23. That is to say, the format conversion unit 24 reads a high priority packet from the high priority buffer 22 with taking priority over the low priority packet. Also, while the format conversion unit 24 is reading data of a low priority packet from the low priority buffer 23, even if there is a transmission request from the high priority buffer 22, the format conversion unit 24 reads the high priority packet after completion of reading the low priority packet. The format conversion unit 24 directly outputs the read high priority packet or low priority packet to the L2 processing unit 25.

On the other hand, when “mode1”, that is to say, a transmission mode of dividing and converting the preceding packet into fragment packets while data of the low-priority preceding packet is being transmitted is specified by an input user parameter, the format conversion unit 24 performs the following processing.

That is to say, the format conversion unit 24 adds an option header and an option footer to a low priority packet read from the low priority buffer 23. Also, the format conversion unit 24 updates the individual values, such as “IHL”, “Total Length”, and “Header Checksum”, and the like in the IP header in accordance with the contents and the length of the option header and the option footer. Then, when the format conversion unit 24 does not receive a transmission request from the high priority buffer 22 while the format conversion unit 24 is reading data of the low priority packet, the format conversion unit 24 outputs a packet including the IP header, the option header, the data, and the option footer to the L2 processing unit 25.

Also, when the format conversion unit 24 receives a transmission request from the high priority buffer 22 while reading data of the low priority packet, that is to say, while transmitting data of the low-priority preceding packet, the format conversion unit 24 further performs the following processing in addition to adding an option header and an option footer. That is to say, the format conversion unit 24 stops reading from the low priority buffer 23, and adds a new IP header at the end of the read data. That is to say, when the format conversion unit 24 receives a transmission request from the high priority buffer 22 while reading data of the low priority packet, the format conversion unit 24 outputs a packet including an IP header, an option header, read data, a new IP header, and an option footer to the L2 processing unit 25. Thereby, the low-priority preceding packet is fragmented while data of the preceding packet is being transmitted. Accordingly, at this point in time, a “fragment packet A1” including the read data of the low priority packet, that is to say, a first half part of data (hereinafter, sometimes referred to as “first half data”) of the low-priority preceding packet is transmitted.

Next, the format conversion unit 24 reads a high priority packet from the high priority buffer 22, and directly outputs the read high priority packet to the L2 processing unit 25. Thereby, the high-priority succeeding packet is transmitted.

After the format conversion unit 24 has completed reading the high priority packet, if the format conversion unit 24 receives no new transmission request from the high priority buffer 22, the format conversion unit 24 reads an untransmitted part of the low priority packet that has been read halfway before, that is to say, a second half part of data (hereinafter, sometimes referred to as “the second half data”) of the low-priority preceding packet from the low priority buffer 23. Then, the format conversion unit 24 adds an IP header and an option header to the beginning of the second half data, and adds an option footer to the end of the second half data. At this time, the format conversion unit 24 does not add a new IP header to the second half data. Thus, the format conversion unit 24 outputs a packet including an IP header, an option header, the second half data, and an option footer to the L2 processing unit 25. Accordingly, at this point in time, a “fragment packet A2” including the second half data is transmitted.

The L2 processing unit 25 adds an Ether header, and an FCS to the packet that is input from the format conversion unit 24, and outputs the packet formed by those to the L1 processing unit 26.

The L1 processing unit 26 performs L1 processing, for example, coding processing, modulation processing, and digital to analog conversion processing, and the like on the packet that is input from the L2 processing unit 25, and transmits the packet having subjected to the L1 processing to the packet reception apparatus 3 through the network 4.

<Configuration of Packet Reception Apparatus>

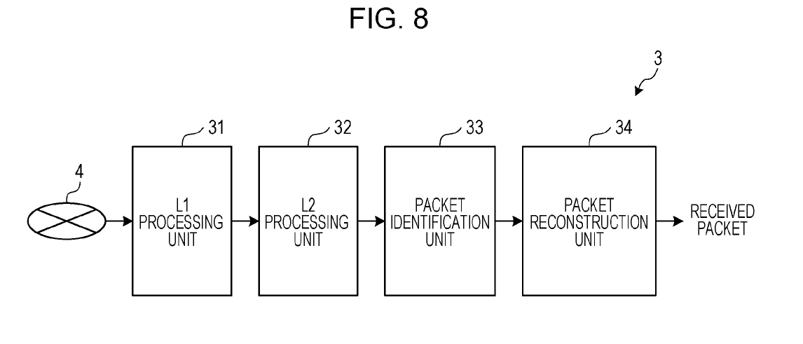

FIG. 8 is a functional block diagram illustrating an example of a packet reception apparatus according to the first embodiment. The packet reception apparatus 3 illustrated in FIG. 8 includes an L1 processing unit 31, an L2 processing unit 32, a packet identification unit 33, and a packet reconstruction unit 34.

The L1 processing unit 31 receives packets transmitted from the packet transmission apparatus 2 through the network 4. The L1 processing unit 31 performs processing at L1, for example, analog to digital conversion processing, demodulation processing, and demodulation processing, and the like on the received packet, and outputs the packet having subjected to the L1 processing to the L2 processing unit 32.

The L2 processing unit 32 removes the Ether header and the FCS from the packet input from the L1 processing unit 31, and outputs the packet after the removal of the Ether header and the FCS to the packet identification unit 33.

If the packet input from the L2 processing unit 32 includes an option header, the packet identification unit 33 refers to “Option Code” of the option header to determine the transmission mode. That is to say, the packet identification unit 33 identifies whether the input packet is a packet transmitted in the transmission mode of “mode0”, or a packet transmitted in the transmission mode of “mode1”. Then, the packet identification unit 33 outputs the packet input from the L2 processing unit 32 to the packet reconstruction unit 34 together with the identification result.

The packet reconstruction unit 34 directly outputs the “mode0” packet among the packets input from the L2 processing unit 32 to the subsequent functional unit as a received packet.

On the other hand, the packet reconstruction unit 34 performs the following processing on the “mode1” packet among the packets input from the L2 processing unit 32.

That is to say, the packet reconstruction unit 34 refers to “the Identifier of the new IP header” (FIG. 5) of the option footer, and determines whether a new IP header is included in the packet or not. If a new IP header is included, the packet reconstruction unit 34 refers to the “header length” (FIG. 5) of the option footer, and extracts a new IP header from the packet based on the referenced “header length”. Then, the packet reconstruction unit 34 overwrites the IP header by the extracted new IP header. Also, the packet reconstruction unit 34 removes the option header, and the option footer from the packet. Thereby, a fragment packet formed by the new IP header, and the first half data is obtained.

Also, if a new IP header is not included in the packet, the packet reconstruction unit 34 removes the option header, and the option footer from the packet. Thereby, a fragment packet including the IP header, and the second half data is obtained.

Then, the packet reconstruction unit 34 performs “reassemble processing” for combining the first half data and the second half data to form a packet including the first half data and the second half data, and outputs the formed packet to the subsequent functional unit as the received packet. In this regard, the reassemble processing is performed in the same manner as before.

<Configuration of Packet Transmission Apparatus>

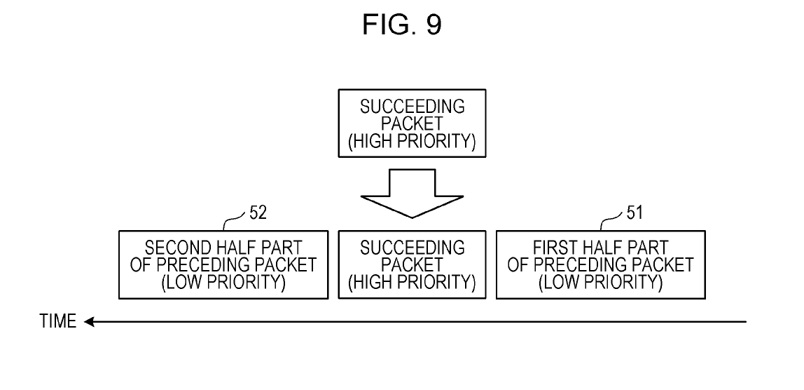

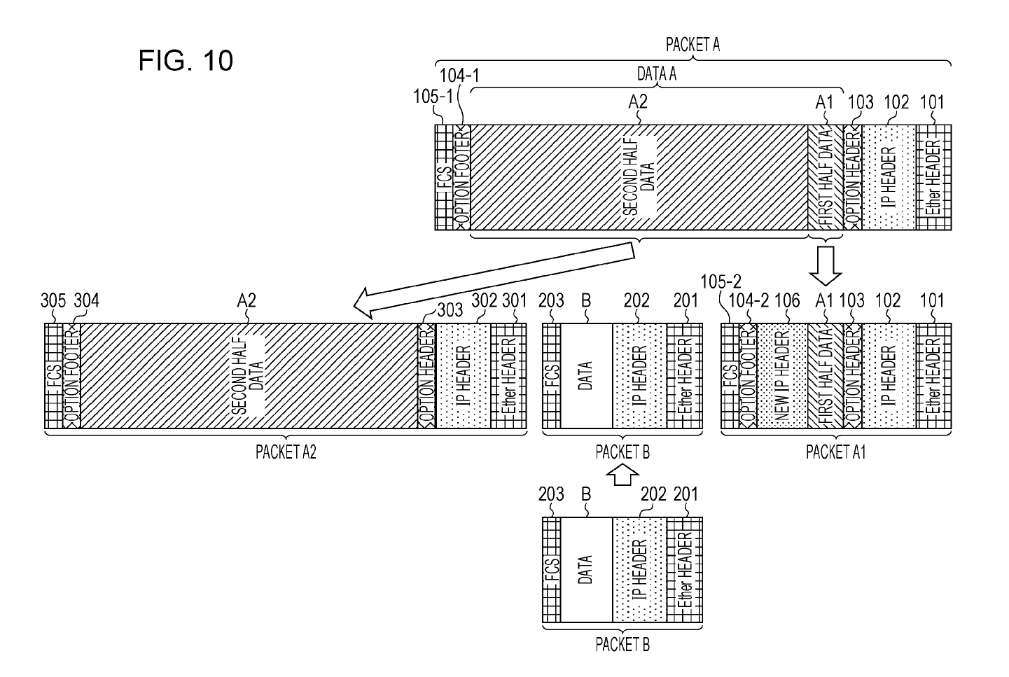

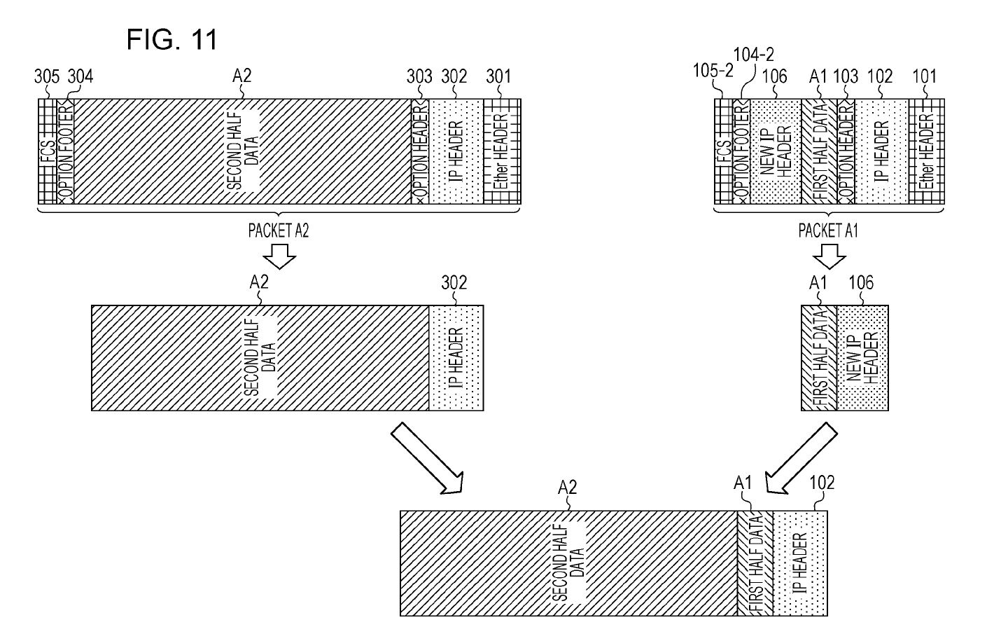

FIG. 9 and FIG. 10 are diagrams for use in explaining operation of the packet transmission apparatus according to the first embodiment.

As illustrated in FIG. 9, when time has come to transmit the high-priority succeeding packet while data included in the low-priority preceding packet is being transmitted, the packet transmission apparatus 2 divides the low-priority preceding packet during the transmission of data into two fragment packets 51 and 52. Then, the packet transmission apparatus 2 transmits the high-priority succeeding packet between the fragment packet 51 and the fragment packet 52. More specifically, the packet transmission apparatus 2 performs operation as illustrated in FIG. 10.

In FIG. 10, while the data A of a packet A is being transmitted, time has come to transmit a packet B. The packet A is a low-priority preceding packet, and the packet B is a high-priority succeeding packet. The time at which the packet B is transmitted comes when the packet B is input into the high priority buffer 22, and a transmission request of the packet B is issued to the format conversion unit 24.

The packet A includes an Ether header 101, an IP header 102, an option header 103, data A, an option footer 104-1, and an FCS 105-1. The “Identification” of the IP header 102 indicates that the packet A is not a fragment packet. The “Option Code” of the option header 103 indicates “mode1”. The “Identifier of the new IP header” of the option footer 104-1 indicates that there is “no” new IP header.

When time has come to transmit the packet B at a point in time of completion of transmission of the first half data A1 out of the data A of the packet A, the packet A is converted into the packet A1 including the first half data A1, and the packet A2 including the second half data A2. The packet A1 and the packet A2 are fragment packets.

Here, at a point in time of starting transmission of data A, transmission of the IP header 102 has already been completed, and thus it is difficult to indicate that the packet A1 is a fragment packet using the IP header 102. Thus, the format conversion unit 24 converts the packet format of the packet A so as to indicate that the packet A1 is a fragment packet. That is to say, the format conversion unit 24 adds a new IP header 106 immediately after the first half data A1. In the new IP header 106, “Identification” indicates that the packet A1 is a fragment packet, the bit1 of “Flags” is set to “0: fragment permitted”, and the bit2 of “Flags” is set to “1: fragment continued”. Also, the starting position of the first half data A1 is indicated by the “Fragment Offset” of the new IP header 106. Also, the format conversion unit 24 adds an option footer 104-2 to immediately after the new IP header 106. The option footer 104-2 is changed from the option footer 104-1. That is to say, the format conversion unit 24 changes the “Identifier of the new IP header” of the option footer 104-1 from the new IP header “nonexistent” to the new IP header “existent” to produce the option footer 104-2. Also, the format conversion unit 24 holds the data length of the first half data A1. Further, the L2 processing unit 25 adds an FCS 105-2 immediately after the option footer 104-2. The FCS105-2 included in the packet A1 is produced by the L2 processing unit 25 by changing the FCS 105-1 together with changing the packet A to the packet A1. The FCS 105-2, which is the end of the packet A1, indicates the final end of the packet A1, and thus by adding the FCS 105-2, transmission of the data A is once compulsorily terminated in the middle of the transmission of the data A.

Next, the format conversion unit 24 reads a packet formed by an IP header 202, and data B from the high priority buffer 22, and directly outputs the packet to the L2 processing unit 25. Accordingly, immediately after completion of the transmission of the packet A1, a packet B formed by an Ether header 201, an IP header 202, data B, and an FCS 203 is transmitted.

The format conversion unit 24 forms a packet including the second half data A2 after completion of transmission of the packet B. That is to say, the format conversion unit 24 reads the second half data A2, which is the remaining data of the data A from the low priority buffer 23. The format conversion unit 24 adds an IP header 302, an option header 303, and an option footer 304 to the read second half data A2. An Ether header 301 and an FCS 305 are added by the L2 processing unit 25. In the IP header 302, the “Identification” indicates that the packet A2 is a fragment packet, the bit1 of “Flags” is set to “0: fragment permitted”, the bit2 of “Flags” is set to “0: final fragment”. The starting position of the second half data A2 in the data A is indicated by the “Fragment Offset” of the IP header 302. The starting position of the second half data A2 in the data A is calculated by the data length of the first half data A1, which is held by the format conversion unit 24. The “Option Code” of the option header 303 indicates “mode1”, and the “Identifier of the new IP header” of the option footer 304 indicates that a new IP header is “nonexistent”.

<Operation of Packet Reception Apparatus>

FIG. 11 is a diagram for use in explaining operation of the packet reception apparatus according to the first embodiment.

The packet reception apparatus 3 receives the packet A1 and the packet A2, which are two fragment packets converted from the packet A by the packet transmission apparatus 2 as described above. The new IP header 106 indicates that the packet A1 is a fragment packet, and the IP header 302 indicates that the packet A2 is a fragment packet. Also, the “Option Code” of the option headers 103 and 303 indicate “mode1”.

The L2 processing unit 32 removes the Ether header 101 and the FCS 105-2 from the packet A1. Accordingly, a packet formed by the IP header 102, the option header 103, the first half data A1, the new IP header 106, and the option footer 104-2 is input into the packet reconstruction unit 34. Since the “Identifier of the new IP header” of the option footer 104-2 indicates that the new IP header is “existent”, the packet reconstruction unit 34 extracts the new IP header 106 based on the “header length” of the option footer 104-2. The packet reconstruction unit 34 holds the IP header 102, and then replaces the IP header 102 with the extracted new IP header 106. After replacing the IP header, the packet reconstruction unit 34 removes the option header 103 and the option footer 104-2. Thereby, a packet to which the new IP header 106 is added immediately before the first half data A1 is obtained.

Also, the L2 processing unit 32 removes the Ether header 301 and the FCS 305 from the packet A2. Accordingly, a packet formed by the IP header 302, the option header 303, the second half data A2, and the option footer 304 is input into the packet reconstruction unit 34. Since the “Identifier of the new IP header” of the option footer 304 indicates that the new IP header is “nonexistent”, the packet reconstruction unit 34 determines that a new IP header is not added to the second half data A2. Thus, the packet reconstruction unit 34 removes the option header 303 and the option footer 304. Thereby, a packet to which the IP header 302 is added immediately before the second half data A2 is obtained.

Then, the packet reconstruction unit 34 reassembles a packet formed by the new IP header 106 and the first half data A1, and a packet formed by the IP header 302 and the second half data A2 into a packet formed by the IP header 102, the first half data A1, and the second half data A2. This reassemble processing is performed in the same manner as a related-art reassemble processing particularly based on the “Fragment Offsets” of the new IP header 106 and the IP header 302.

<Processing of Packet Transmission Apparatus>

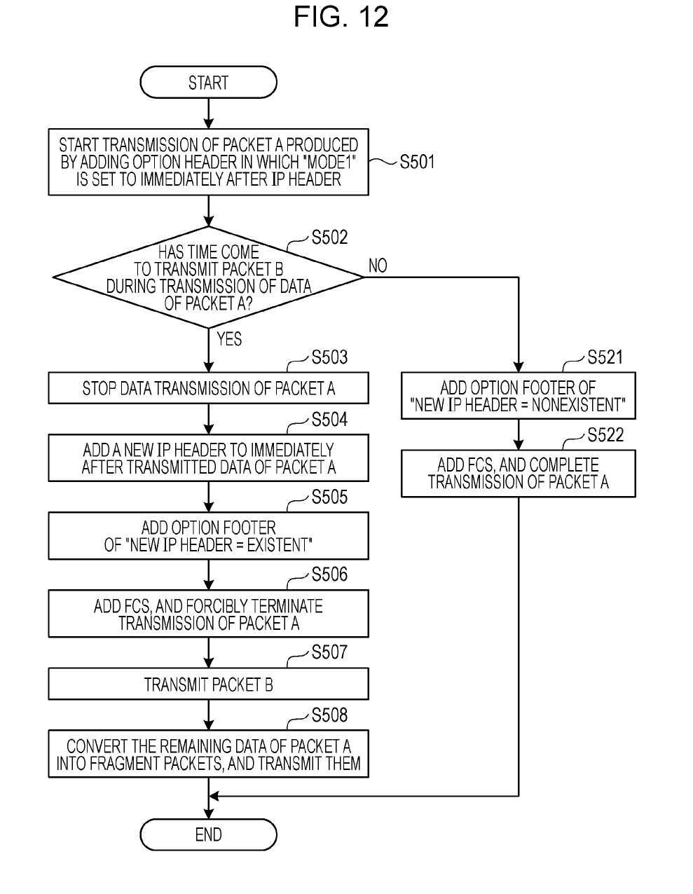

FIG. 12 is a method for use in explaining processing of the packet transmission apparatus according to the first embodiment. The method illustrated in FIG. 12 is started when time has come to transmit the packet A. The time to transmit the packet A comes when a packet A is input into the low priority buffer 23, and a transmission request of the packet A is issued to the format conversion unit 24. In FIG. 12, the packet A is a low-priority preceding packet, and the packet B is a high-priority succeeding packet.

The packet transmission apparatus 2 starts transmission of the packet A, which is produced by adding the option header in which “mode1” is set to immediately after the IP header (operation S501).

The packet transmission apparatus 2 determines whether time has come to transmit the packet B during data transmission of the packet A (operation S502).

When time has come to transmit the packet B during data transmission of the packet A (operation S502: Yes), the packet transmission apparatus 2 stops the data transmission of the packet A in the middle of the data transmission of the packet A (operation S503).

The packet transmission apparatus 2 adds a new IP header immediately after the transmitted data of the packet A (operation S504). The new IP header indicates a fragment packet.

The packet transmission apparatus 2 further adds an option footer including the “Identifier of the new IP header” indicating that a new IP header is “existent” (operation S505).

The packet transmission apparatus 2 further adds an FCS, and compulsorily terminates transmission of the packet A once in the middle of data transmission of the packet A (operation S506).

Next, the packet transmission apparatus 2 transmits the packet B (operation S507).

Next, the packet transmission apparatus 2 changes the remaining data of the packet A into fragment packets, and transmits them (operation S508).

When time has not come to transmit the packet B during data transmission of the packet A (operation S502: No), the packet transmission apparatus 2 adds an option footer including the “Identifier of the new IP header” indicating that a new IP header is “nonexistent” (operation S521).

Next, the packet transmission apparatus 2 further adds an FCS, and completes transmission of the packet A (operation S522).

Processing of Packet Transmission Apparatus

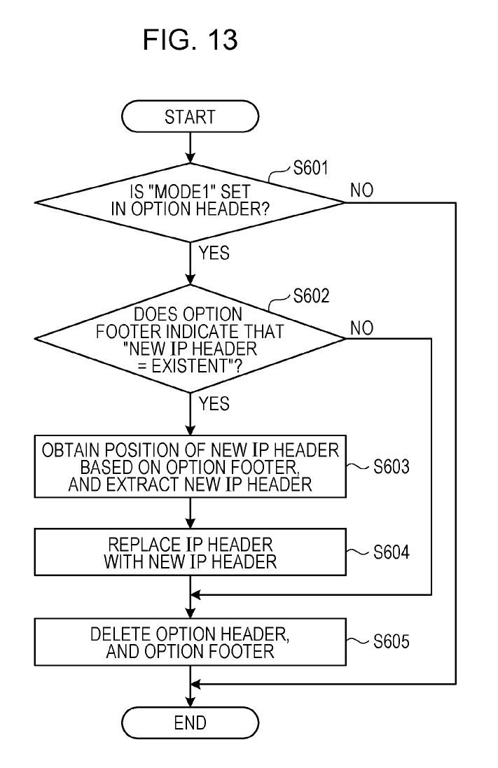

FIG. 13 is a method for use in explaining processing of the packet reception apparatus according to the first embodiment. The method illustrated in FIG. 13 is started when a packet is received.

The packet reception apparatus 3 determines whether “mode1” is set in the option header or not (operation S601).

If “mode1” is set in the option header (operation S601: Yes), the packet reception apparatus 3 determines whether the “Identifier of the new IP header” of the option footer indicates that a new IP header is “existent” or not (operation S602).

If the “Identifier of the new IP header” of the option footer indicates that a new IP header is “existent” (operation S602: Yes), the packet reception apparatus 3 obtains the position of the new IP header based on the option footer, and extracts the new IP header (operation S603).

Next, the packet reception apparatus 3 replaces the IP header with the new IP header (operation S604).

Next, the packet reception apparatus 3 deletes the option header and the option footer (operation S605).

If “mode1” is not set in the option header (operation S601: No), the processing is terminated.

If the “Identifier of the new IP header” of the option footer indicates that a new IP header is “nonexistent” (operation S602: No), the processing proceeds to operation S605.

As described above, according to the first embodiment, the packet transmission apparatus 2 includes the format conversion unit 24, and the L1 processing unit 26. While the format conversion unit 24 is transmitting data included in the low-priority preceding packet, if time has come to transmit the high-priority succeeding packet earlier than preceding packet, the following processing is performed. That is to say, the format conversion unit 24 performs conversion processing in which a preceding packet is divided and converted into two fragment packets while data included in the low-priority preceding packet is being transmitted. The L1 processing unit 26 transmits the high-priority succeeding packet between the two fragment packets after conversion.

In this manner, at a point in time when time has come to transmit the high-priority succeeding packet, it becomes possible to insert transmission of the high-priority succeeding packet during transmission of the low-priority preceding packet without waiting for transmission completion of the low-priority preceding packet. Thereby, it is possible to avoid a transmission delay of the high priority packet, which is caused by the existence of the low priority packet. In particular, if the high-priority succeeding packet is an NTP packet, it is possible to take synchronism in time with high precision by suppressing fluctuations of NTP packets.

Also, the format conversion unit 24 adds an IP header indicating that the packet including the transmitted data is a fragment packet immediately after the transmitted data among the data included in the low-priority preceding packet so as to form a head fragment packet.

In this manner, it is possible to convert the preceding packet into fragment packets while data included in the low-priority preceding packet in the middle of the transmission.

Also, the format conversion unit 24 determines whether to perform the above-described conversion processing in accordance with the user parameter.

In this manner, it is possible for the user to freely set as to whether to perform the above-described conversion processing by the packet transmission apparatus 2.

Also, according to the first embodiment, the packet reception apparatus 3 includes the L1 processing unit 31, and the packet reconstruction unit 34. The L1 processing unit 31 receives a plurality of fragment packets divided from one packet. The packet reconstruction unit 34 performs the following processing when the plurality of fragment packets are produced by converting one packet while data included in one packet is in the middle of the transmission. That is to say, the packet reconstruction unit 34 reconstructs one packet from a plurality of fragment packets based on the IP header added immediately after the data included in the head fragment packet among the plurality of fragment packets.

In this manner, when a plurality of fragment packets are produced by converting one packet while data included in the one packet is in the middle of the transmission, it is possible to reconstruct the one packet from the plurality of fragment packets.

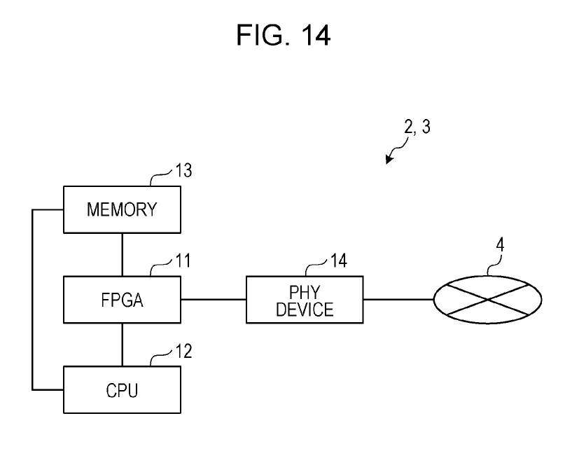

1. It is possible to achieve the packet transmission apparatus 2 and the packet reception apparatus 3 according to the above-described embodiments by the following hardware configuration. FIG. 14 illustrates an example of a hardware configuration of the packet transmission apparatus, and the packet reception apparatus. As illustrated in FIG. 14, the packet transmission apparatus 2 and the packet reception apparatus 3 include one or more field programmable gate arrays (FPGA) 11, one or more central processing units (CPU) 12, a memory 13, and a PHY device 14 as hardware components.

The priority identification unit 21, the format conversion unit 24, and the L2 processing unit 25 are achieved by the one or more FPGAs 11. The high priority buffer 22, and the low priority buffer 23 are achieved by the memory 13. The L1 processing unit 26 is achieved by the PHY device 14. Also, the priority identification unit 21, the format conversion unit 24, and the L2 processing unit 25 are achieved by one or more processors, such as the one or more CPUs 12, one or more digital signal processors (DSP), or the like.

The L1 processing unit 31 is achieved by the PHY device 14. The L2 processing unit 32, the packet identification unit 33, and the packet reconstruction unit 34 are achieved by the one or more FPGAs 11. Also, the L2 processing unit 32, the packet identification unit 33, and the packet reconstruction unit 34 may be achieved by one or more processors, such as the one or more CPUs 12, the one or more DSPs, or the like.

2. In the above-described embodiments, an example of the case where one packet is divided into two fragment packets is given. However, it is possible to apply the disclosed technique to the case where one packet is divided into three or more fragment packets. That is to say, the packet transmission apparatus 2 ought to transmit a high-priority succeeding packet between the first fragment packet and the second fragment packet among a plurality of fragment packets having a low priority. Preferably, the first fragment packet is a head fragment packet among a plurality of fragment packets, and the second fragment packet is the next fragment packet to the first fragment packet. Also, for example, in FIG. 10, when time has come to transmit a packet C having a high priority while the second half data A2 of the packet A2, which is a fragment packet, is in the middle of the transmission, the packet A2 may be divided into two fragment packets in the same manner as the packet A is divided into the packet A1 and the packet A2.

3. A packet transmitted from the packet transmission apparatus 2 may be a received packet that has been received by the packet transmission apparatus 2 from another apparatus. That is to say, the packet transmission apparatus 2 may relay the packet to the packet reception apparatus 3. For example, either or both the packet A or/and the packet B in FIG. 10 may be relay packets in the packet transmission apparatus 2.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A packet transmission apparatus, comprising:
while data included in a preceding packet having a low priority is being transmitted without fragmentation, when time has come to transmit a succeeding packet having a priority higher than that of the preceding packet, one or more processors configured to perform conversion processing for dividing the preceding packet into a plurality of fragment packets while the data is being transmitted; and
a transmission unit configured to transmit the succeeding packet between a first fragment packet, and a second fragment packet among the plurality of fragment packets.

2. The packet transmission apparatus according to claim 1, wherein
after transmitted data out of the data, the one or more processors are configured to add an IP header indicating that a packet including the transmitted data is a fragment packet so as to form a head packet out of the plurality of fragment packets.

3. The packet transmission apparatus according to claim 1, wherein
the one or more processors are configured to determine whether to perform the conversion processing in accordance with a user parameter.

4. A packet reception apparatus, comprising:
a reception unit configured to receive a plurality of fragment packets produced by dividing one packet; and
when the plurality of fragment packets are packets produced by converting the one packet while transmission of data included in the one packet, a reconstruction unit configured to reconstruct the one packet from the plurality of fragment packets based on an IP header added immediately after data included in a head fragment packet among the plurality of fragment packets.
